(19) United States
(12) Patent Application Publication
(10) Pub. No.: US 2025/0355307 A1
(43) Pub. Date: Nov. 20, 2025

(54) APPARATUS CAPABLE OF SWITCHING MIRROR STATE AND IMAGE DISPLAYING STATE

(71) Applicant: Stanley Electric Co., Ltd., Tokyo (JP)

(72) Inventors: Keisuke KATO, Tokyo (JP); Yudai TANABE, Tokyo (JP)

(21) Appl. No.: 18/860,981

(22) PCT Filed: Apr. 6, 2023
(86) PCT No.: PCT/JP2023/014195

§ 371 Date: Oct. 28, 2024

(30) Foreign Application Priority Data
Apr. 28, 2022 (JP) 2022-074571

(51) Int. Cl. G02F 1/137; G02F 1/1335; G02F 1/1337; G02F 1/1343

(52) U.S. Cl. CPC G02F 1/137; G02F 1/133528; G02F 1/133742; G02F 1/13439

(57) ABSTRACT

In apparatus capable of switching a mirror state and an image displaying state, a liquid crystal mirror unit 2′ is provided ahead of an image displaying unit 1. The liquid crystal mirror unit 2′ has as a vertical alignment-type liquid crystal layer 21′, first and transparent electrodes 22, 23 sandwiching the vertical alignment-type liquid crystal layer 21′, an absorption-type polarizing plate 24 having a first transmitting axis TX1 for transmitting first linearly polarized light and absorbing second linearly polarized light intersecting the first linearly polarized light, and a reflection-type polarizing plate 25 having a second transmitting axis TX2 for transmitting the second linearly polarized light and reflecting the first linearly polarized light. A control circuit 3 sweeps a drive voltage V_{D} between the first and second transparent electrodes of the liquid crystal mirror unit 2′ for a predetermined sweeping time T_{S} to increase the drive voltage from an OFF state of the vertical alignment-type liquid crystal layer 21′ via an initial voltage V_{S} to a predetermined voltage Vₘₐₓ causing an ON state of the vertical alignment-type liquid crystal layer 21′.

This application is a U.S. National Stage Application under 35 U.S.C § 371 of International Patent Application No. PCT/JP2023/014195 filed Apr. 6, 2023, which claims the benefit of priority under 35 U.S.C. § 119 to Japanese Patent Application No. 2022-074571 filed Apr. 28, 2022, the disclosures of all of which are hereby incorporated by reference in their entireties.

### TECHNICAL FIELD

The present invention relates to an apparatus capable of switching a mirror state and an image displaying state. The apparatus capable of switching a mirror state and an image displaying state can be used in a rear-view mirror for a vehicle (see: Patent Literature 1).

### BACKGROUND TECHNOLOGY

FIG. 9 is a diagram illustrating a prior art apparatus capable of switching a mirror state and an image displaying state (see: Patent Literature 2).

In the apparatus capable of switching a mirror state and an image displaying state of FIG. 9, a liquid crystal mirror unit 2 is provided on the front side of an image displaying unit 1. The liquid crystal mirror unit 2 is constructed by a twisted nematic (TN)-type liquid crystal layer 21, a pair of transparent electrodes 22 and 23 sandwiching the TN-type liquid crystal layer 21, an absorption-type polarizing plate 24 provided on the side of the transparent electrode 22 having a horizontal transmission axis TX1 for transmitting first linearly polarized light and absorbing second linearly polarized light intersecting the first linearly polarized light, and a reflection-type polarizing plate 25 provided on the side of the transparent electrode 23 having a vertical transmission axis TX2 for transmitting the second linearly polarized light and reflecting the first linearly polarized light. The image displaying unit 1 and a drive voltage V_{D} between the transparent electrodes of the liquid crystal mirror unit 2 are controlled by a control circuit 3 such as a microcomputer.

FIG. 10 is a timing diagram of the drive voltage V_{D} between the transparent electrodes of the liquid crystal mirror unit 2 of FIG. 9.

As illustrated in FIG. 10, when the drive voltage V_{D} between the transparent electrodes is in an ON state (V_{D}=Vₘₐₓ), since the polarization axis of the TN-type liquid crystal layer 21 is unchanged, the first linearly polarized light of external light EL passes through the absorption-type polarizing plate 24 and the liquid crystal layer 21, and then, is reflected by the reflection-type polarizing plate 25. Further, the reflected first linearly polarized light passes through the liquid crystal layer 21 and then, is emitted from the absorption-type polarizing plate 24. That is, the liquid crystal mirror unit 2 is in a mirror state S1. In this case, note that the image displaying unit 1 is turned off by the control circuit 3.

On the other hand, when the drive voltage V_{D} between the transparent electrodes is in an OFF state (for example, V_{D}=0V), since the polarization axis of the TN-type liquid crystal layer 21 is changed, the first linearly polarized light of external light EL passes through the absorption-type polarizing plate 24 and is changed by the TN-type liquid crystal layer 21 into second linearly polarized light, which further passes through the reflection-type polarizing plate 25. Similarly, image light IL from the image displaying unit 1 passes through the reflection type polarizing plate 25 to become second linearly polarized light, which is converted by the TN-type liquid crystal layer 21 into first linearly polarized light, which then, is emitted from the absorption-type polarizing plate 24. That is, the liquid crystal mirror unit 2 is in a transparent state S2. In this case, note that, when the image displaying unit 1 is turned on by the control circuit 3, the image displaying unit 1 becomes an image displaying state such as a white displaying state.

### PRECEDING TECHNOLOGY LITERATURE

### Patent Literature

Patent Literature 1: Japanese Patent Publication No. 2021-138195
Patent Literature 2: Japanese Patent Publication No. 2003-202565 (Japanese Patent No. 4348061)

### SUMMARY OF THE INVENTION

### Problems to be Solved by the Invention

In the apparatus capable of switching a mirror state and an image switching as illustrated in FIG. 9, when a vertical alignment (VA)-type liquid crystal layer is used instead of the TN-type liquid crystal layer 21, the following problems are created.

In a mirror state in FIG. 11, when the drive voltage V_{D} between the transparent electrodes is 0 V, liquid crystal molecules 21a are almost perpendicular to rubbing ribs L along the rubbing process direction on a vertical alignment layer; in this case, however, the vertical direction of the liquid crystal molecules 21a such as a pretilt angle 89.0° fluctuate according to the rubbing ribs L which are unevenness on the alignment layer surface by the rubbing process, unevenness of glass substrates which are not shown, and so on. An example of the mirror state S1 of this apparatus is illustrated in (A) of FIG. 13.

Next, when the drive voltage V_{D} between the transparent electrodes rapidly rises from 0 V to Vₘₐₓ, a strong electric field makes a part of the liquid crystal molecules 21a fall nonuniformly along separate directions different from the direction defined by the rubbing process due to the backflow phenomenon caused by the vertical direction of the liquid crystal molecules 21a, thus creating a region exhibiting a transparent state S2I of the liquid crystal molecules 21b. In this case, the transparent state S2I of the apparatus is illustrated in (B) of FIG. 13, which clearly points out display unevenness. The interval of the display unevenness is about 30 mm, and its duration is about 1 sec. Further, after several seconds such as 1 second has passed, as illustrated in (B) of FIG. 12, a transparent state S2II of liquid crystal molecules 21c is realized to exhibit an alignment direction defined by the rubbing. In this case, a transparent state S2II of the apparatus is illustrated in (C) of FIG. 13. Note that display images displayed in the transparent state S2I of (B) of FIG. 13 and the transparent state S2II of (C) of FIG. 13 are totally white display images in order to easily confirm the display nonuniformity.

### Means for Solving the Problems

In order to solve the above-mentioned problems, in an apparatus capable of switching a mirror state and an image displaying state, comprising: an image displaying unit for emitting image light; a liquid crystal mirror unit provided on a light emitting side of the image displaying unit; and a control circuit which controls the image displaying unit and the liquid crystal mirror unit, the liquid crystal mirror unit comprises a vertical alignment-type liquid crystal layer; a first transparent electrode provided on an opposite side of the vertical alignment-type liquid crystal layer against the image displaying unit; a second transparent electrode provided on a side of the vertical alignment-type liquid crystal layer for the image displaying unit; an absorption-type polarizing plate on an opposite side of the first transparent plate against the vertical alignment-type liquid crystal layer and having a first transmitting axis for transmitting first linearly polarized light and absorbing second linearly polarized light intersecting the first linearly polarized light; and a reflection-type polarizing plate provided on an opposite side of the second transparent plate against the vertical alignment-type liquid crystal layer and having a second transmitting axis, perpendicular to the first transmitting axis, for transmitting the second linearly polarized light and reflecting the first linearly polarized light, the control circuit sweeping a drive voltage between the first and second transparent electrodes of the liquid crystal mirror unit for a predetermined sweeping time to increase the drive voltage from an OFF state of the vertical alignment-type liquid crystal layer via an initial voltage to a predetermined voltage causing an ON state of the vertical alignment-type liquid crystal layer, wherein said predetermined voltage is a saturated voltage of said drive voltage between said first and second transparent electrodes when light transmittance of said liquid crystal mirror unit is saturated, wherein said initial voltage is not larger than 40% of said saturated voltage, wherein said sweeping time is not smaller than 70 ms and not larger than 1000 ms.

### Effect of the Invention

According to the present invention, since the drive voltage between the transparent electrodes is swept for the predetermined sweeping time to increase the drive voltage from the OFF state of the vertical alignment-type liquid crystal layer via the initial voltage to the predetermined voltage causing the ON state, a transient state occurs between the OFF state and the ON state, so that the liquid crystal molecules of the vertical alignment-type liquid crystal layer fall uniformly along the same direction, thus creating display uniformity.

### BRIEF DESCRIPTION OF THE DRAWINGS

FIG. 1 is a diagram illustrating an embodiment of the apparatus capable of switching a mirror state and an image displaying state according to the present invention.

FIG. 2 is a detailed cross-sectional view of the liquid crystal mirror unit of FIG. 1.

FIG. 3 is a timing diagram of the drive voltage between the transparent electrodes of the liquid crystal mirror unit of FIG. 1.

FIG. 4 is a flowchart for explaining setting method of the drive voltage between the transparent electrodes of FIG. 3.

FIG. 5 is a graph showing the drive voltage between the transparent electrodes/light transmittance characteristic used in the saturated drive voltage between the transparent electrodes setting step 401 of FIG. 4.

FIG. 6 is a table used in the initial drive voltage between the transparent electrodes setting step 402 of FIG. 4.

FIG. 7 is a table used in the sweeping time setting step 403 of FIG. 4.

FIG. 8 is a timing diagram illustrating modifications of the drive voltage between the transparent electrodes of FIG. 3.

FIG. 9 is a diagram illustrating a prior art apparatus capable of switching a mirror state and an image displaying state.

FIG. 10 is a timing diagram of the drive voltage between the transparent electrodes of the liquid crystal mirror unit of FIG. 9.

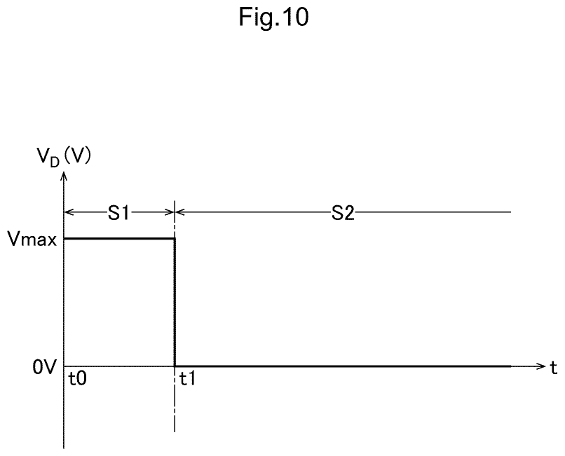

FIG. 11 is a timing diagram of the drive voltage between the transparent electrodes of FIG. 9 where the liquid crystal layer of FIG. 9 is of a vertical alignment (VA)-type.

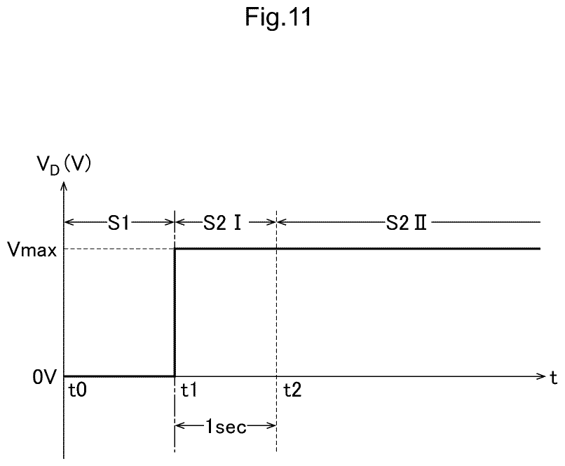

FIG. 12 is a diagram explaining the problems in the prior art apparatus capable of switching a mirror state and an image displaying state where the vertical alignment (VA)-type liquid crystal layer is used, where (A) illustrates liquid crystal molecules in the mirror state, and (B) illustrates liquid crystal molecules in a transition from the mirror state to a transparent state.

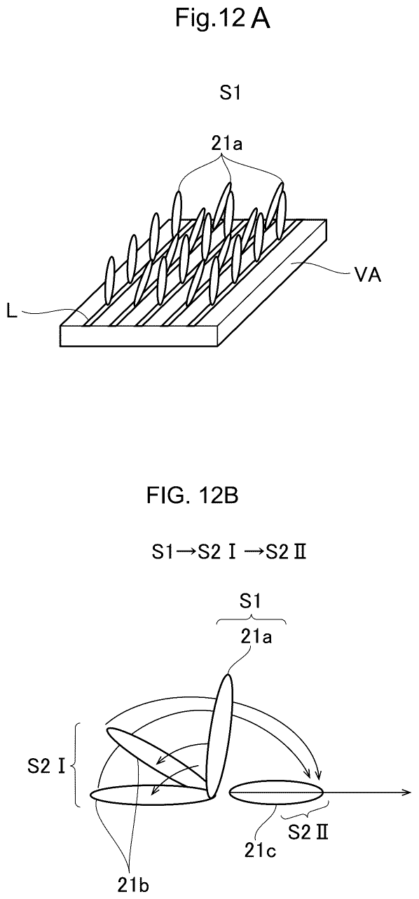

FIG. 13 is photos illustrating display examples of the mirror state, the transparent state S2I and the transparent state S2II, respectively, of FIG. 9.

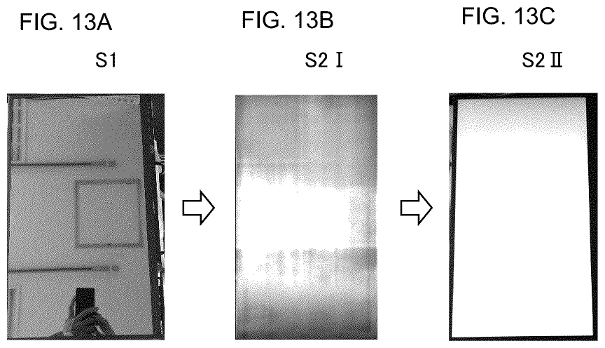

### EMBODIMENTS

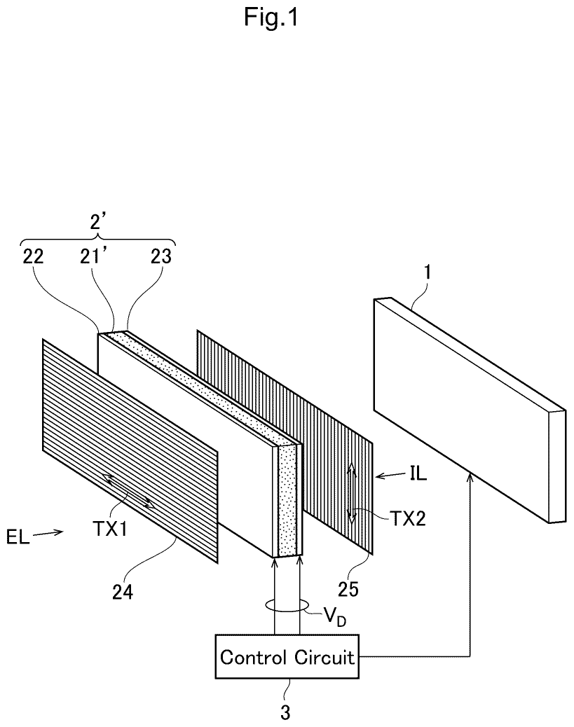

FIG. 1 is a diagram illustrating an embodiment of the apparatus capable of switching a mirror state and an image displaying state according to the present invention.

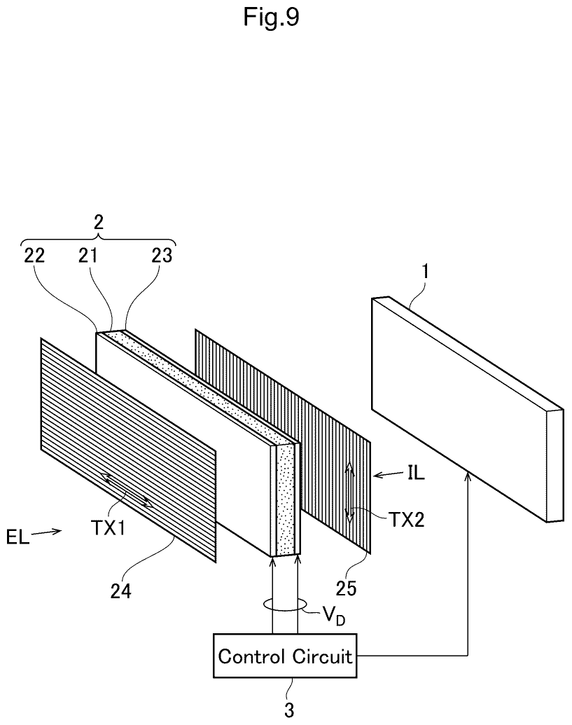

In FIG. 1, provided instead of the liquid crystal mirror unit 2 of FIG. 9 is a liquid crystal mirror unit 2′, where a vertical alignment (VA)-type liquid crystal layer 21′ is provided instead of the twisted nematic (TN)-type liquid crystal layer 21.

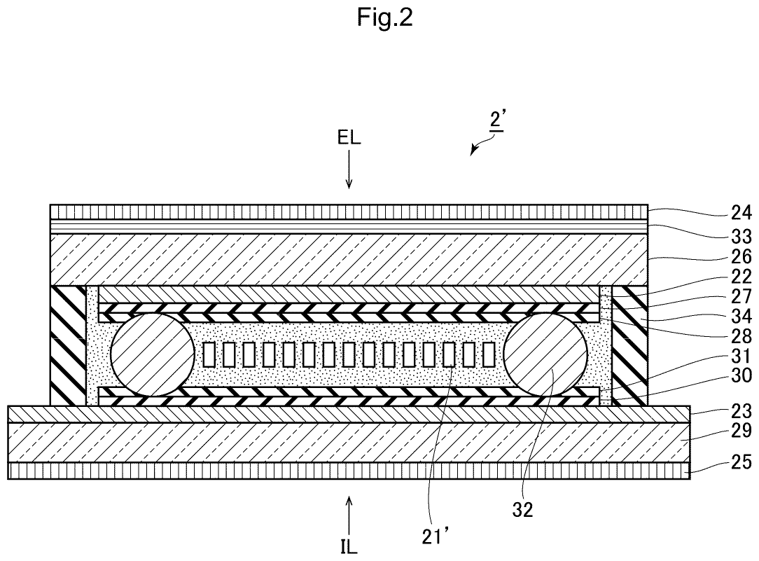

FIG. 2 is a detailed cross-sectional view of the liquid crystal mirror unit 2′ of FIG. 1.

As illustrated in FIG. 2, an upper glass substrate 26, a transparent electrode 22, an insulating layer 27 and an upper vertical alignment layer 28 are provided as an upper structure, and a lower glass substrate 29, a transparent electrode 23, an insulating layer 30 and a lower vertical alignment layer 31 are provided as a lower structure, so that a vertical alignment-type liquid crystal layer 21′ is supported by the insulating layers 27 and 30, an insulating layer 34 and spacers 32. Note that the transparent electrode 22 and 23 are electrically isolated by the insulating layers 27, 30 and 34 and are supported by the spacers 32. Provided outside of the upper glass substrate 26 is an absorption-type polarizing plate 24 through an optical compensating plate 33, and also, provided outside of the lower glass substrate 29 is a reflection-type polarizing plate 25. Also, a rubbing process using anti-parallel orientation, for example, is performed upon opposing surfaces of the upper vertical alignment layer 28 and the lower vertical alignment layer 31.

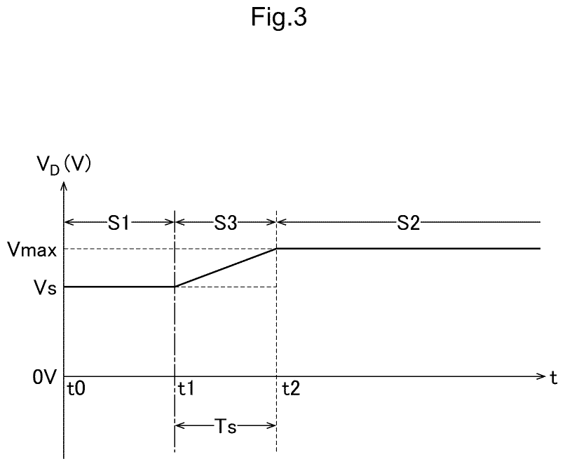

FIG. 3 is a timing diagram of the drive voltage V_{D} between the transparent electrodes of the liquid crystal mirror unit 2′ of FIG. 1.

In FIG. 3, the drive voltage V_{D} between the transparent electrodes is linearly swept in a transient state S3 for a sweeping time Tₛ to increase the voltage V_{D} from a mirror state S1 via an initial drive voltage Vₛ to a saturated drive voltage Vₘₐₓ of a transparent state S2. In this case, as will be explained later, the saturated drive voltage Vₘₐₓ, the initial drive voltage Vₛ and the sweeping time Tₛ are set so as to create display uniformity.

From time t0 to time t1, when the drive voltage V_{D} is at a low level, the direction of polarized light passing through the VA-type liquid crystal layer 21′ is unchanged. Therefore, the first linearly polarized light of external light EL which has passed through the absorption-type polarizing plate 24 passed through the VA-type liquid crystal layer 21′ and then, is reflected by the reflection-type polarizing plate 25. Further, the reflected first linearly polarized light passes through the VA-type liquid crystal layer 21′ and then, is emitted from the absorption-type liquid crystal layer 24. That is, the liquid crystal mirror unit 2′ is in a mirror state S1. Also, in this case, the image displaying unit 1 is turned off by the control circuit 3.

Next, from time t1 to time t2, the drive voltage V_{D} between the transparent electrodes is swept from Vₛ to rise to Vₘₐₓ. In this case, the long axes of liquid crystal molecules of the VA-type liquid crystal layer 21′ are relatively gradually changed. Also, in this case, the long axes of liquid crystal molecules of the TN-type liquid crystal layer 21′ are arranged as a whole along the rubbing processing direction, and also, liquid crystal molecules sloped along different orientations due to the fluctuations are aligned with the orientations of other surrounding liquid crystal molecules. That is, the liquid crystal molecules of the VA-type liquid crystal layer 21′ fall from the vertical direction to the rubbing process direction. Therefore, there is display uniformity in a transient state S3 switched from the mirror state S1 to the transparent state S2. Finally, at time t2, the drive voltage V_{D} between the transparent electrodes becomes Vₘₐₓ, so that the change of the long axes of the liquid crystal molecules of the VA-type liquid crystal layer 21′ has completed. As a result, the polarized direction of the first linearly polarized light of the external light EL, which passed through the absorption-type polarizing plate 24, is changed by the VA-type liquid crystal layer 21′, and then, the polarized direction-changed polarized light passes through the reflection-type polarizing plate 25. Similarly, image light from the image displaying unit 1 passes through the reflection-type polarizing plate 25 to become second linearly polarized light. Then, the polarized state of the second linearly polarized light is changed by the VA-type liquid crystal layer 21′, and then this second linearly polarized light is emitted from the absorption-type polarizing plate 24. That is, the liquid crystal mirror unit 2′ becomes in a transparent state S2. In this case, note that, when the image displaying unit 1 is turned on, the image displaying unit 1 becomes in an image displaying state, for example, a white displaying state. Here, if chiral material with about d/p=0.25 (where d is a gap between liquid crystal molecules and p is a chiral pitch) is added to the liquid crystal layer, the liquid crystal molecules under Vₘₐₓ generates about 90° chiral between the transparent electrodes 22 and 23, to exhibit a similar optical rotatory to in the TN-type liquid crystal layer. In this case, when the absorption-type polarizing plate 24 and the reflection-type polarizing plate 25 are arranged in a crossed Nicols arrangement, the external light EL passes through the absorption-type polarizing plate 24 to become first linearly polarized light, and then, is changed by the VA-type liquid crystal layer 21′ into second linearly polarized light. Also, image light IL passes through the reflection-type polarizing plate 25 to become second linearly polarized light, and then, is changed by the VA-type liquid crystal layer 21′ into first linearly polarized light.

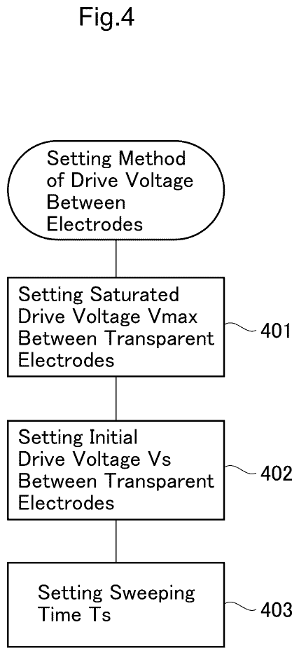

Next, the setting of the saturated drive voltage Vₘₐₓ between the transparent electrodes, the initial drive voltage Vₛ between the transparent electrodes and the sweeping time Tₛ will be explained with reference to FIG. 4.

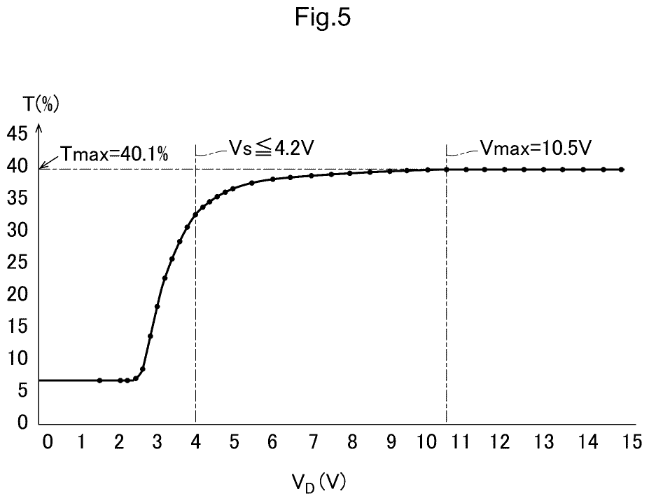

First, at step 401, the saturated drive voltage Vₘₐₓ between the transparent electrodes is set. The saturated drive voltage Vₘₐₓ is set by measuring the drive voltage between the transparent electrodes/light transmittance (V-T) characteristic of the liquid crystal mirror unit 2′. A V-T characteristic as illustrated in FIG. 5 was obtained as the V-T characteristic of the liquid crystal mirror unit 2′ of FIG. 1. From FIG. 5, the saturated drive voltage Vₘₐₓ between the transparent electrodes where the light transmittance Tis saturated is 10.5 V, and also, its saturated light transmittance Tₘₐₓ was 40.1%. Note that the light transmittance T=100% is a transmittance obtained in a measuring system without the liquid crystal mirror unit 2′.

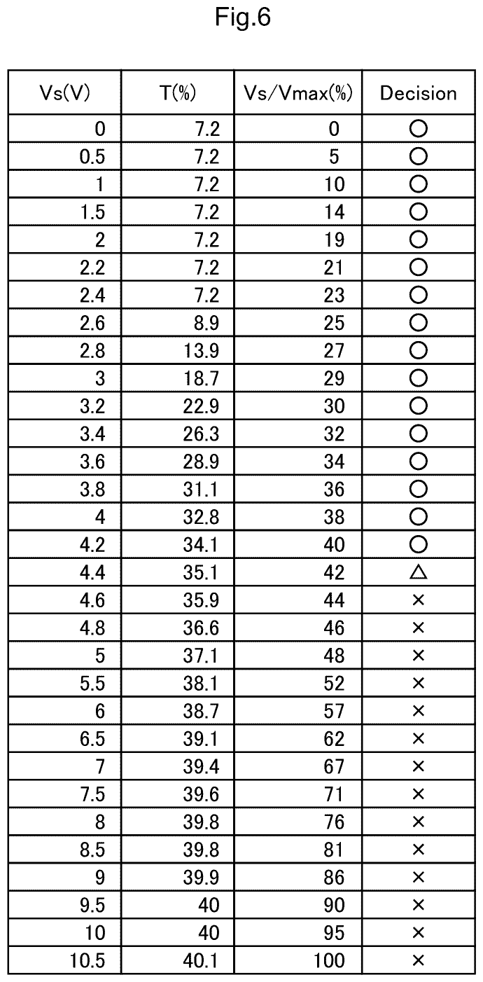

Next, at step 402, the initial drive voltage Vₛ between the transparent electrodes is set. Since display nonuniformity is observed at an interval of about 30 mm, a mini display unit having a display area 260 mm×470 mm and a rear-view mirror having a display area 60 mm×260 mm are used to visually inspect exterior appearance of display nonuniformity in a transparent state from V=Vₛ to V=Vₘₐₓ=10.5 V, thereby to obtain a result as illustrated in FIG. 6. In this case, the sweeping time Tₛ was fixed at 100 ms. As a result, in order to create display uniformity, the initial drive voltage Vₛ between the transparent electrodes was Vₛ=0˜4.2 V, i.e., Vₛ=0˜0.4 Vₘₐₓ. That is, when Vₛ is not smaller than 4.4 V (not smaller than 0.42·Vₘₐₓ), the liquid crystal molecules are nonuniformly sloped due to the backflow to generate display nonuniformity. On the other hand, when Vₛ is not larger than 4.2 V (not larger than 0.4·Vₘₐₓ), the liquid crystal molecules are sloped along the same direction with no backflow, so that generation of display nonuniformity is suppressed. That is, it is preferable that the initial drive voltage Vₛ is not larger than 40% of the saturated drive voltage Vₘₐₓ.

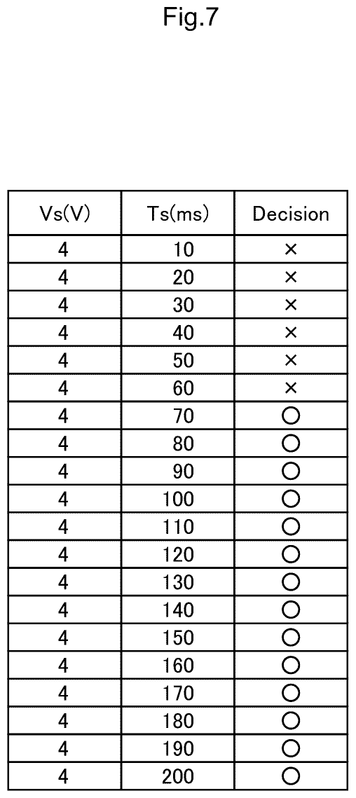

Next, at step 403, the sweeping time Tₛ is set. In this case, Vₛ=4 V and Vₘₐₓ=10.5 are fixed and the sweeping time Tₛ varies from 10 to 200 ms, and a mini display unit having a display area 260 mm×470 mm and a rear-view mirror having a display area 60 mm×260 mm are used to visually inspect exterior appearance of display nonuniformity in a transparent state from V=Vₛ to V=Vₘₐₓ=10.5 V, thereby to obtain a result as illustrated in FIG. 7. As a result, in order to create display uniformity, the sweeping time Tₛ was 70˜200 ms. That is, when the sweeping time Tₛ is not larger than 60 ms, the liquid crystal molecules are nonuniformly sloped due to the backflow to generate display nonuniformity. On the other hand, when the sweeping time Tₛ is not smaller than 70 ms, after the liquid crystal molecules are sloped, the liquid crystal molecules are sloped along the same direction, so that generation of display nonuniformity is suppressed. That is, when the sweeping time Tₛ is not smaller than 70 ms, no backflow phenomenon is generated. Note that, the response speed of liquid crystal molecules is dependent upon the temperature: about 50 ms at 25° C. and about 500 ms at −30° C. Therefore, in consideration of the backflow phenomenon and the practical switching operation between a mirror state and an image display state, it is preferable that the sweeping time Tₛ is 70 to 200 ms, and more preferably, 70 ms.

When the pixel size is large, it is easy to visually observe display nonuniformity due to the backflow phenomenon. In the embodiment of the present invention, since the interval of display nonuniformity is about 30 mm and is observable, a preferable result with display uniformity can be obtained in a liquid crystal mirror unit 2′ having a pixel size of not smaller than 30 mm. Also, in the apparatus capable of switching a mirror state S1 and an image displaying state S2, a size equivalent to the display area can be applied to the pixel size. For example, it is confirmed that the apparatus with a liquid crystal mirror unit of a pixel size of 260 mm×470 mm functioned. The present invention solves display nonuniformity visually confirmed in an apparatus capable of switching a mirror state S1 and an image displaying state S2 to which a relatively large pixel size of not smaller than 30 mm×30 mm is applied.

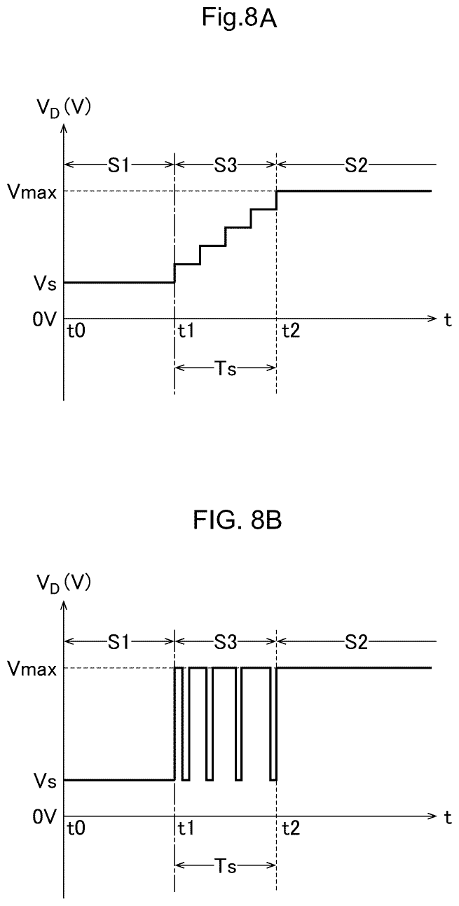

FIG. 8 is a timing diagram illustrating modifications of the drive voltage V_{D} between the transparent electrodes of FIG. 3.

As illustrated in (A) of FIG. 8, the drive voltage V_{D} between the transparent electrodes in the sweeping time Tₛ can be multi-stepwise such as two-stepwise or more-stepwise. As a result, since the drive voltage V_{D} between the transparent electrodes is output in a digital form, the control circuit 3 can be simplified. Also, since the liquid crystal molecules respond to an effective value of the input signal, the drive voltage V_{D} between the transparent electrodes in the sweeping time Tₛ can be a pulse-width modulated (PWM) waveform as illustrated in (B) of FIG. 8. In this case, the ON-duty ratio is increased with time. Also, in this case, the control circuit 3 can be simplified. Note that, when the drive voltage V_{D} between the transparent electrodes is linearly swept, an analog process is required so that the control circuit 3 is complicated.

In the above-described embodiment, note that the image display unit is a liquid crystal display unit or an organic electroluminescence display unit.

Note that the present invention can be applied to any alterations within the obvious scope of the above-mentioned embodiments.

### POSSIBILITY OF UTILIZATION IN INDUSTRY

The apparatus according to the present invention can be applied to a smart rear-view mirror, a mirror display for housing equipment, a digital signage and the like.

### DESCRIPTION OF THE SYMBOLS

1: image display unit
2, 2′: liquid crystal mirror unit
21: TN-type liquid crystal layer
21′: VA-type liquid crystal layer
22, 23: transparent electrodes
24: absorption-type polarizing plate having a first transmitting axis for linearly first polarized light
25: reflection-type polarizing plate having a second transmitting axis for second linearly polarized light
26: upper glass substrate
27: insulating layer
28: upper vertical alignment layer
29: lower glass substrate
30: insulating layer
31: lower vertical alignment layer
32: spacers
33: optical compensating plate

1. An apparatus capable of switching a mirror state and an image displaying state, comprising:
an image displaying unit for emitting image light;
a liquid crystal mirror unit provided on a light emitting side of said image displaying unit; and
a control circuit which controls said image displaying unit and said liquid crystal mirror unit,
said liquid crystal mirror unit comprising:
a vertical alignment-type liquid crystal layer;
a first transparent electrode provided on an opposite side of said vertical alignment-type liquid crystal layer against said image displaying unit;
a second transparent electrode provided on a side of said vertical alignment-type liquid crystal layer for s said image displaying unit;
an absorption-type polarizing plate on an opposite side of said first transparent plate against said vertical alignment-type liquid crystal layer and having a first transmitting axis for transmitting first linearly polarized light and absorbing second linearly polarized light intersecting said first linearly polarized light; and
a reflection-type polarizing plate provided on an opposite side of said second transparent plate against said vertical alignment-type liquid crystal layer and having a second transmitting axis, perpendicular to said first transmitting axis, for transmitting said second linearly polarized light and reflecting said first linearly polarized light,
said control circuit sweeping a drive voltage between said first and second transparent electrodes of said liquid crystal mirror unit for a predetermined sweeping time to increase said drive voltage from an OFF state of said vertical alignment-type liquid crystal layer via an initial voltage to a predetermined voltage causing an ON state of said vertical alignment-type liquid crystal layer,
wherein said predetermined voltage is a saturated voltage of said drive voltage between said first and second transparent electrodes when light transmittance of said liquid crystal mirror unit is saturated,
wherein said initial voltage is not larger than 40% of said saturated voltage,
wherein said sweeping time is not smaller than 70 ms and not larger than 1000 ms.

2. (canceled)

3. The apparatus as set forth in claim 1, wherein sweeping from said initial voltage to said predetermined voltage is linear.

4. The apparatus as set forth in claim 1, wherein sweeping from said initial voltage to said predetermined voltage is multi-stepwise more than one-stepwise.

5. The apparatus as set forth in claim 1, wherein sweeping from said initial voltage to said predetermined voltage is pulse-width modulated, the closer each pulse to application of said predetermined voltage, the larger the ON-duty radio of said pulse.

6. (canceled)

7. (canceled)

8. The apparatus as set forth in claim 1, wherein said initial voltage is not larger than 4.2 V.
